(19) United States
(12) Patent Application Publication
(10) Pub. No.: US 2026/0219461 A1
(43) Pub. Date: Jul. 30, 2026

(54) METHODS AND APPARATUSES FOR FIBER ALIGNMENT

(71) Applicant: IonQ, Inc., College Park, MD (US)

(72) Inventors: Sergey DUSHENKO, Rockville, MD (US); James David SIVERNS, Bothell, WA (US); John Michael HANNEGAN, II, Glenn Dale, MD (US); Ryan Stephen BOWLER, Kirkland, WA (US)

(21) Appl. No.: 19/461,299

(22) Filed: Jan. 27, 2026

Related U.S. Application Data
(60) Provisional application No. 63/751,806, filed on Jan. 30, 2025.

(51) Int. Cl. G02B 6/42

(52) U.S. Cl. CPC G02B 6/4226

(57) ABSTRACT

Aspects of the disclosure may include sequentially emitting a plurality of photons, aligning first photons of the plurality of photons to a first multi-mode (MM) optical fiber of a plurality of MM optical fibers, the first MM optical fiber having a first numerical aperture larger than remaining numerical apertures of remaining optical fibers of the plurality of MM optical fibers, aligning second photons of the plurality of photons to a second MM optical fiber based on first alignment of the first photons to the first MM optical fiber, the second MM optical fiber having a second numerical aperture smaller than the first numerical aperture, and aligning third photons of the plurality of photons to the SM fiber based on second alignment of the second photons to the second MM optical fiber, the SM fiber having a third numerical aperture smaller than the second numerical aperture.

### CROSS REFEENCE TO RELATED APPLICATIONS

The current application claims priority to, and the benefit of, United States Provisional Application No. 63/751,806 filed January 30, 2025 and entitled “METHODS AND APPARATUSES FOR FIBER ALIGNMENT,” the contents of which are hereby incorporated by reference in their entireties.

### TECHNICAL FIELD

The current application relates to the alignment of a single mode optical fiber.

### BACKGROUND

Certain operations in a quantum processing unit (QPU) may require a single photon or a series of photons to be coupled into a single-mode (SM) fiber. The purpose of this coupling is to route the photon(s) to other devices such as, but not limited to, interferometers , networking switches, and detectors. However, due to the small core size of SM fibers, coupling single photons into a SM fiber may be difficult, time consuming, and subject to drifts that require repeated re-alignment. This constant need for re-alignment may lead to increasing system down-time and/or a reduction in the rate at which photons may be coupled into the SM fiber, which ultimately may cause a reduction in performance metrics such as, but not limited to, networking rates, state detection fidelity, and fluorescence detection. As such, improvements in coupling a single photon into a SM fiber may be desirable.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the disclosure may include a method for sequentially emitting a plurality of photons, aligning first photons of the plurality of photons to a first multi-mode

(MM) optical fiber of a plurality of MM optical fibers, the first MM optical fiber having a first numerical aperture larger than remaining numerical apertures of remaining optical fibers of the plurality of MM optical fibers, aligning second photons of the plurality of photons to a second MM optical fiber based on first alignment of the first photons to the first MM optical fiber, the second MM optical fiber having a second numerical aperture smaller than the first numerical aperture, and aligning third photons of the plurality of photons to the SM fiber based on second alignment of the second photons to the second MM optical fiber, the SM fiber having a third numerical aperture smaller than the second numerical aperture.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a system for aligning photons to a single mode fiber according to aspects of the present disclosure.

FIG. 2 illustrates an example of an alignment system according to aspects of the present disclosure.

FIG. 3 illustrates an example of a method for aligning photons to a single mode fiber according to aspects of the present disclosure.

FIG. 4 illustrates an example of a computer system according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

An aspect of the present disclosure is to reduce the amount of time required to perform coupling of photons into a single mode (SM) fiber and/or automate the re-alignment resulting in less system downtime and deliver consistently higher performance metrics. In some aspects, a fiber array is mounted on a multi-axis stage (including one or more of x, y, z, pitch, roll, and/or yaw axes) whose axes are capable of being remotely computer controlled. The fiber array includes of a series of multi-mode (MM) fibers arranged from largest core size and/or numerical aperture (NA) to the smallest core size and/or NA. The MM fibers may have a surface core target area that is 10 times, 100 times, 1,000 times, 10,000 times, or more, bigger than the core area of the SM fiber. Consequently, an advantage according to aspects of the present disclosure includes making detection of the initial signal a much easier task.

Additionally or alternatively, because the translational and/or rotational alignment is easier due to a larger core area size, beginning the alignment process with the MM fiber enable better initial detection of light coming at an angle with respect to the fiber core and/or can have larger NA than SM fiber. As such, the series of MM fibers provides a step-down in core size and NA to enable the alignment of photons into the largest MM fiber core before moving (e.g., via a horizontal translation) to a smaller core, performing another coupling optimization, and then moving to the next MM fiber, and so forth and so on. At the end of the series of the MM cores is the SM fiber. After aligning to the smallest MM fiber core, the device may be moved (e.g., translated horizontally) again to provide photon coupling into the SM fiber. At this point, the final coupling optimization can be performed.

Each axis of the multi-axis stage can have its position be computer controlled, which allows the alignment process to be partially or wholly automated by a program that can perform a search to find the optimal position for each fiber core based on the detected photon count and/or to perform calibrations to re-align the device interleaved with the QPUs operations.

In some aspects of the present disclosure, once the alignment is completed the fiber array may be also used to estimate SM fiber coupling efficiency as described below. In conventional schemes, an accurate SM fiber coupling efficiency may be challenging to estimate due to uncertainty in the absolute number of photons produced (e.g., due to drifts in calibrations for laser frequencies and powers, beam pointing, etc.), difficulty in accurately estimating all the photon losses at multiple other elements in the optical path, and/or disentangling losses on other elements from the SM fiber coupling efficiency.

In certain aspects, imperfect mode overlap between the incoming beam and the optical mode of the SM may cause reduced coupling efficiency of the light from the free space into the fiber. This may be caused by optical aberrations that distort the incoming beam mode on the length scale comparable to the desirable beam size that needs to match the mode of the SM fiber. However, the MM fibers may have core size many times larger than that length scale, allowing to couple the majority of light into the MM fiber despite the aberrations. Hence, counts detected through the MM fiber may be approximated as a benchmark to compare counts detected through the SM fiber and/or to determine the light coupling efficiency. In addition, measuring the photon counts through all of the step-down sizes of MM fibers, the relevant scale of aberrations may be detected at the point where the coupling efficiency begins to decrease with the size of the core of the MM fibers.

In an aspect, while free-space light detectors like single-photon avalanche diodes (SPADs) or photomultiplier tube (PMTs) may serve similar purpose of a high-coupling efficiency light collector that is not-sensitive to the coupling-reducing aberrations, it is often challenging (if not impossible) to place them at the location of the SM fibers since it significantly increases footprint of the system and complexity of the optical design. Detectors placed at other locations don’t have the same elements in the optical path, and hence cannot accurately reproduce all the defects/non-idealities that may impact the coupling efficiency.

Moreover, using MM fibers with NA matching NA of the SM and MM fibers with NA larger than NA of the SM fiber can help differentiate coupling losses from the incoming beam not matching the spatial mode of the SM fiber vs incoming beam being angle with respect to the optical axis of the fiber, i.e., differentiate angular vs spatial and translational misalignment.

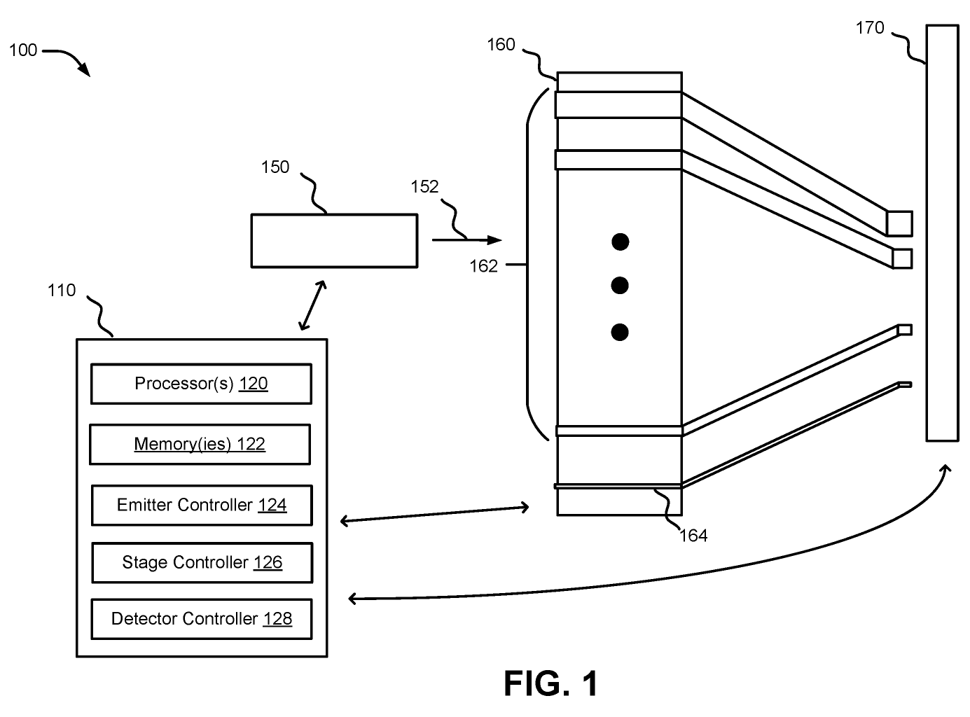

FIG. 1 illustrates an example of a system 100 for optical alignment according to aspects of the present disclosure. The system 100 may include a controller 110 configured to control an emitter 150, an alignment system 160, and/or a detector 170. The controller 110 may include one or more processors 120 configured to execute instructions stored in one or more memories 122 for performing the functions described herein.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, controllers, digital signal processors (DSPs), field programmable gate arrays (FPGAs), programmable logic devices (PLDs), state machines, gated logic, discrete hardware circuits, and other suitable hardware configured to perform the various functionality described herein.

In some aspects, the controller 110 may include the one or more memories 122. The one or more memories 122 may include software instructions and/or hardware instructions. The processor 120 may execute the instructions to implement aspects of the present disclosure. The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

In some aspects of the present disclosure, the controller 110 may include an emitter controller 124 configured to control the emitter 150. The controller 110 may include a stage controller 126 configured to control the movement of the alignment system 160. The controller 110 may include a detector controller 128 configured to control the detector 170.

In certain aspects, the system 100 may include the emitter 150 configured to emit photons 152. The emitter 150 may be configured to emit photons sequentially (i.e., one photon at a time). The emitter 150 may be configured to track a number of photons emitted.

In one aspect of the present disclosure, the system 100 may include an alignment system 160 having a plurality of multi-mode (MM) fibers 162 and at least one single mode (SM) fiber 164. The plurality of MM fibers 162 may be arranged from the largest MM fiber to the smallest MM fiber. The at least one SM fiber 164 may be smaller than the smallest MM fiber. The alignment system 160 will be described in more detail below.

In an aspect of the present disclosure, the system 100 may include a detector 170 configured to detect one or more of the photons 152 emitted by the emitter 150 and guided by one or more of the plurality of MM fibers 162 and/or the at least one SM fiber 164. The detector 170 may be able to count a number of photons detected.

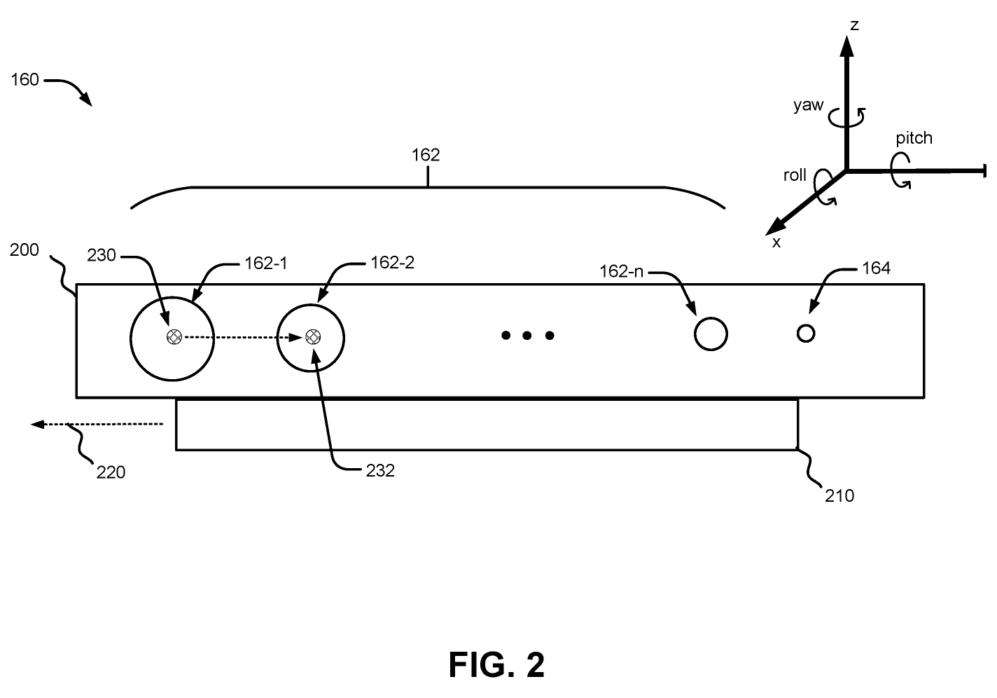

FIG. 2 illustrates an example of an alignment system 160 according to aspects of the present disclosure. The alignment system 160 may include a frame 200 configured to hold the plurality of multi-mode (MM) fibers 162 and the at least one single mode (SM) fiber 164. The frame 200 may be configured to hold the plurality of multi-mode (MM) fibers 162 and the at least one single mode (SM) fiber 164 at a particular spacing between the neighboring fibers. The alignment system 160 may include a stage 210 configured to move in one or more directions, including but not limited to moving linearly along the x, y, or z axes and/or rotates along the roll, pitch, and/or yaw axes. Other movements may be possible according to aspects of the present disclosure.

In some aspects, the alignment system 160 may include one or more servo motors, step motors, and/or other devices to move the stage 210.

In some aspects of the present disclosure, referring to FIGS. 1 and 2, during operation, the controller 110 and/or the emitter controller 124 may cause the emitter 150 to emit the photons 152 toward the alignment system 160. The controller 110 and/or the stage controller 126 may move the stage 210 and/or the frame 200 (e.g., one or more x, y, and/or z translations, and/or rotations along the roll, pitch, and/or yaw axes). The controller 110 and/or the stage controller 126 may move the stage 210 until the detector 170 detects at least some of the photons 152 via the first MM fiber 162-1. The controller 110 and/or the stage controller 126 may continue to move the stage 210 until the detector 170 detects a first maximum ratio of first incident photons of the photons 152 emitted by the emitter 150 and first detected photons exiting the first MM fiber 162-1. The adjustment to achieve the first maximum ratio may optimize the coupling between the emitter 150 and the first MM fiber 162-1.

Next, the controller 110 and/or the stage controller 126 may be configured to move the stage 210 so the detector 170 detects the photons 152 via the second MM fiber 162-2. Due to the movement (220) of the stage 210, the second MM fiber 162-2 may occupy a space previously occupied by the first MM fiber 162-1. Specifically, the second MM fiber 162-2 may move “into” the a space previously occupied by the first MM fiber 162-1. As a result, the photons 152 may transition from impinging on the first MM fiber 162-1 at a first spot 230 to the second MM fiber 162-2 at a second spot 232. After the movement (22), the controller 110 and/or the stage controller 126 may continue to move the stage 210 until the detector 170 detects a second maximum ratio of second incident photons of the photons 152 emitted by the emitter 150 and second detected photons exiting the second MM fiber 162-2. The adjustment to achieve the second maximum ratio may optimize the coupling between the emitter 150 and the second MM fiber 162-2.

In some aspects, the movement of the photons 152 from the first spot 230 to the second spot 232 may be a linear movement (e.g., translation along the y-axis), a rotational movement (e.g., rotation along the roll-axis), and/or other movements. In certain cases, the movement may be predetermined by the controller 110 and/or the stage controller 126 to reduce the total alignment time.

In some cases, the steps described above may be repeated until the photons 152 move (220) from the (n-1)^{th} MM fiber 162-(n-1) to the n^{th} MM fiber 162-n.

Next, in certain aspects of the present disclosure, the controller 110 and/or the stage controller 126 may be configured to move the stage 210 so the detector 170 detects the photons 152 via the SM fiber 164. Due to the movement (22) of the stage 210, the SM fiber 164 may occupy a space previously occupied by the n^{th} MM fiber 162-n. Specifically, the SM fiber 164 may move “into” the a space previously occupied by the n^{th} MM fiber 162-n. After the movement, the controller 110 and/or the stage controller 126 may continue to move the stage 210 until the detector 170 detects a third maximum ratio of third incident photons of the photons 152 emitted by the emitter 150 and third detected photons exiting the SM fiber 164. The adjustment to achieve the third maximum ratio may optimize the coupling between the emitter 150 and the SM fiber 164, which may be a goal for the scheme described above.

In some aspects of the present disclosure, the controller 110 may be configured to determine the coupling efficiency of the SM fiber 164 based on the first, second, and/or third maximum ratios. Specifically, the controller 110 may rely on the first maximum ratio to determine an “optimum” coupling efficiency for the system 100. This may be the ratio of the number of photons emitted by the emitter 150 that may be detected by the detector 170. The deviation of this ratio from 1 (no loss) may be due to aberration, misalignment, defects in the emitter 150 and/or the detector 170, transmission loss, and/or other non-idealities.

In an aspect, the first maximum ratio may be compared to the third maximum ratio. The difference in the two ratios may be used to determine the coupling efficiencies. For example, if the first maximum ratio is 98% (e.g., the detector 170 detects 98 photons out of 100 photons emitted by the emitter 150 via the first MM fiber 162-1) and the third maximum ratio is 92% (e.g., the detector 170 detects 92 photons out of 100 photons emitted by the emitter 150 via the SM fiber 164), the controller 110 may determine that the coupling efficiency of the SM fiber 164 is 93.88% (i.e., 92 photons detected out of 98 detectable photons) because it is assumed that 2 photons are not detectable (loss due to various reasons described above.

In the example shown in FIG. 2, the plurality of MM fibers 162 and the SM fiber 164 are shown to be arranged on the frame 200 linearly (a 1-D arrangement). However, this is one of many possible configurations that may be used for the alignment system 160. In one aspect, the plurality of MM fibers 162 and the SM fiber 164 may be arranged on the frame 200 in a matrix configuration (a 2-D arrangement), where the plurality of MM fibers 162 and the SM fiber 164 are disposed in two or more rows and/or two or more columns. In another aspect, the plurality of MM fibers 162 and the SM fiber 164 may be disposed concentrically on a circular frame, where the alignments of the fibers require the circular frame to rotate about an axis to expose the plurality of MM fibers 162 and the SM fiber 164 to the photons transmitted by the emitter 150. In certain aspects, the plurality of MM fibers 162 and the SM fiber 164 may not be arranged in decreasing numerical aperture and/or core size. Other arrangements of the plurality of MM fibers 162 and the SM fiber 164 may also be possible according to various aspects of the present disclosure.

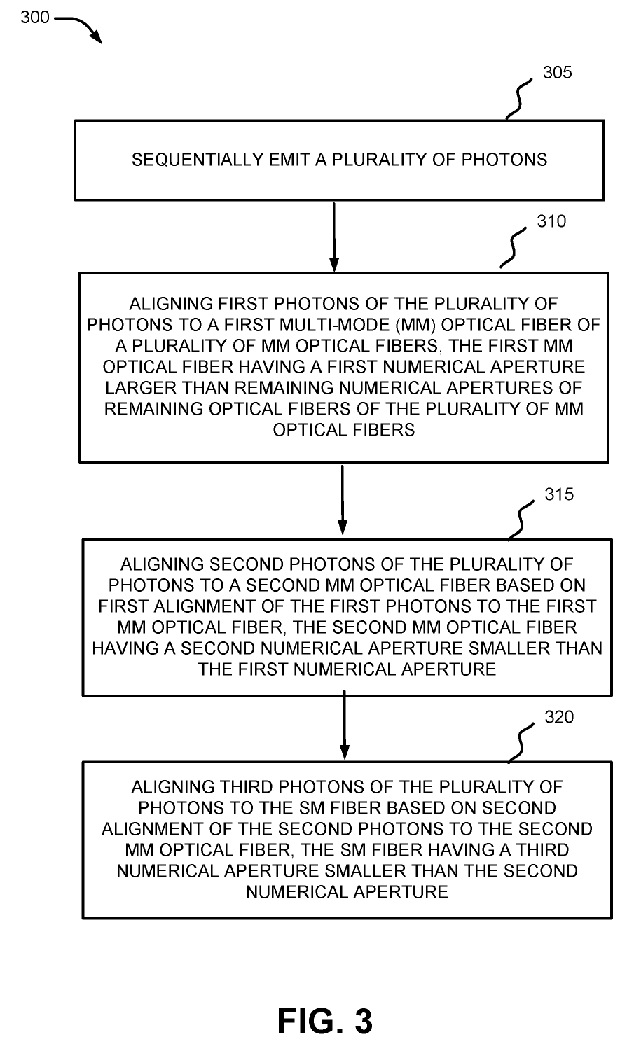

FIG. 3 illustrates an example of a method 300 for aligning a SM fiber according to aspects of the present disclosure. One or more of the controller 110, the one or more processors 120, the one or more memories 122, the emitter controller 124, the stage controller 126, the detector controller 128, the emitter 150, the alignment system

160, the frame 200, the stage 210, and/or the detector 170 may implement the method 300.

At 305, the method 300 may sequentially emit a plurality of photons. For example, one or more of the controller 110, the one or more processors 120, the one or more memories 122, the emitter controller 124, and/or the emitter 150 may be configured to, and/or provide means for sequentially emitting a plurality of photons.

At 310, the method 300 may align first photons of the plurality of photons to a first multi-mode (MM) optical fiber of a plurality of MM optical fibers, the first MM optical fiber having a first numerical aperture larger than remaining numerical apertures of remaining optical fibers of the plurality of MM optical fibers. For example, one or more of the controller 110, the one or more processors 120, the one or more memories 122, the stage controller 126, the alignment system 160, the frame 200, and/or the stage 210 may be configured to, and/or provide means for aligning first photons of the plurality of photons to a first multi-mode (MM) optical fiber of a plurality of MM optical fibers, the first MM optical fiber having a first numerical aperture larger than remaining numerical apertures of remaining optical fibers of the plurality of MM optical fibers.

At 315, the method 300 may align second photons of the plurality of photons to a second MM optical fiber based on first alignment of the first photons to the first MM optical fiber, the second MM optical fiber having a second numerical aperture smaller than the first numerical aperture. For example, one or more of the controller 110, the one or more processors 120, the one or more memories 122, the stage controller 126, the alignment system 160, the frame 200, and/or the stage 210 may be configured to, and/or provide means for aligning second photons of the plurality of photons to a second MM optical fiber based on first alignment of the first photons to the first MM optical fiber, the second MM optical fiber having a second numerical aperture smaller than the first numerical aperture.

At 320, the method 300 may align third photons of the plurality of photons to the SM fiber based on second alignment of the second photons to the second MM optical fiber, the SM fiber having a third numerical aperture smaller than the second numerical aperture. For example, one or more of the controller 110, the one or more processors 120, the one or more memories 122, the stage controller 126, the alignment system 160, the frame 200, and/or the stage 210 may be configured to, and/or provide means for aligning third photons of the plurality of photons to the SM fiber based on second alignment of the second photons to the second MM optical fiber, the SM fiber having a third numerical aperture smaller than the second numerical aperture.

Aspects of the disclosure may include sequentially emitting a plurality of photons, aligning first photons of the plurality of photons to a first multi-mode (MM) optical fiber of a plurality of MM optical fibers, the first MM optical fiber having a first numerical aperture larger than remaining numerical apertures of remaining optical fibers of the plurality of MM optical fibers, aligning second photons of the plurality of photons to a second MM optical fiber based on first alignment of the first photons to the first MM optical fiber, the second MM optical fiber having a second numerical aperture smaller than the first numerical aperture, and aligning third photons of the plurality of photons to the SM fiber based on second alignment of the second photons to the second MM optical fiber, the SM fiber having a third numerical aperture smaller than the second numerical aperture.

Aspects of the present disclosure include any of the methods and/or systems above, further comprising moving, after aligning the first photons to the first MM optical fiber, the second MM optical fiber such that the second MM optical fiber at least partially overlaps with a first region previously occupied by the first MM optical fiber.

Aspects of the present disclosure include any of the methods and/or systems above, further comprising moving, after aligning the second photons to the second MM optical fiber, the SM fiber such that the SM fiber at least partially overlaps with a second region previously occupied by the second MM optical fiber.

Aspects of the present disclosure include any of the methods and/or systems above, wherein moving the SM fiber comprises one or more of translating the SM fiber along one or more axes or rotating the SM fiber around the one or more axes.

Aspects of the present disclosure include any of the methods and/or systems above, further comprising, after aligning the first photons to the first MM optical fiber, sequentially aligning a subset of the plurality of photons to a subset of the plurality of MM optical fibers having decreasing numerical apertures.

Aspects of the present disclosure include any of the methods and/or systems above, wherein the plurality of MM optical fibers are arranged based on numerical apertures of the plurality of MM optical fibers.

Aspects of the present disclosure include any of the methods and/or systems above, wherein a first core area of the first MM optical fiber is at least one thousand times larger than a second core area of the SM optical fiber.

Aspects of the present disclosure include any of the methods and/or systems above, wherein aligning the first photons to the first MM optical fiber comprises emitting the first photons toward the first MM optical fiber and adjusting a first position of the first MM optical fiber to maximize a first ratio of first input photons entering the first MM optical fiber and first output photons exiting the first MM optical fiber.

Aspects of the present disclosure include any of the methods and/or systems above, wherein aligning the second photons to the second MM optical fiber comprises emitting the second photons toward the second MM optical fiber and adjusting a second position of the second MM optical fiber to maximize a second ratio of second input photons entering the second MM optical fiber and second output photons exiting the second MM optical fiber.

Aspects of the present disclosure include any of the methods and/or systems above, wherein aligning the third photons to the SM optical fiber comprises emitting the third photons toward the SM optical fiber and adjusting a third position of the SM optical fiber to maximize a third ratio of third input photons entering the SM optical fiber and third output photons exiting the SM optical fiber.

Aspects of the present disclosure include any of the methods and/or systems above, further comprising estimating a coupling efficiency of the SM optical fiber based on one or more of the first ratio and the third ratio.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

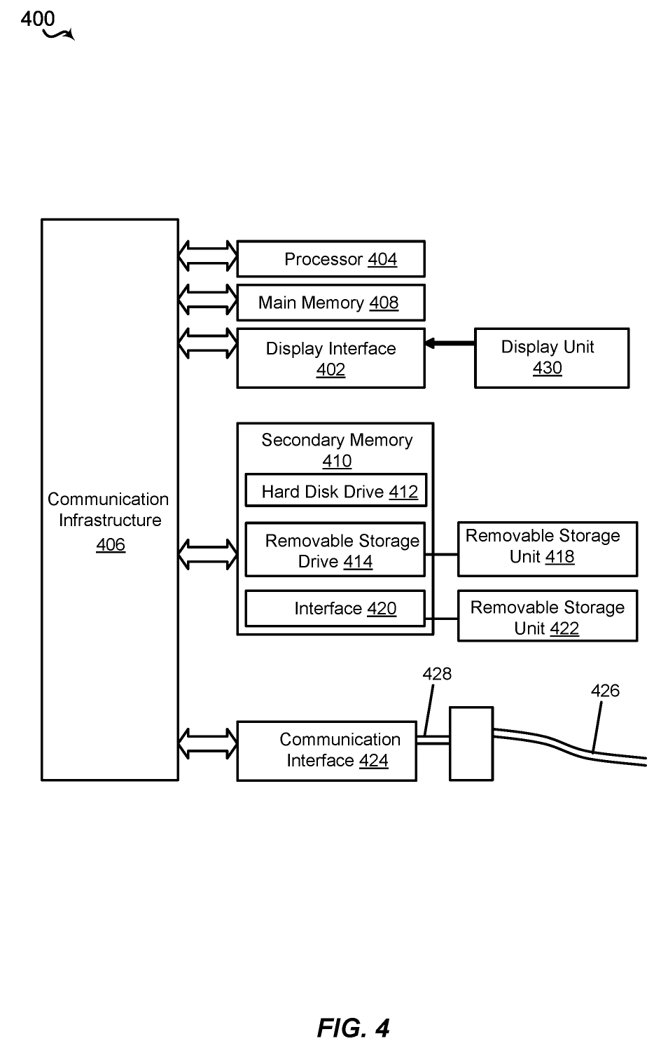

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 400 is shown in FIG. 4. In some examples, the controller 110 may be implemented as the computer system 400 shown in FIG. 4. The controller 110 may include some or all of the components of the computer system 400.

The computer system 400 includes one or more processors, such as processor 404. The processor 404 is connected with a communication infrastructure 406 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 400 may include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include, for example, a hard disk drive 412, and/or a removable storage drive 414, representing a floppy disk drive, a magnetic tape drive, an optical disk drive, a universal serial bus (USB) flash drive, etc. The removable storage drive 414 reads from and/or writes to a removable storage unit 418 in a well-known manner. Removable storage unit 418 represents a floppy disk, magnetic tape, optical disk, USB flash drive etc., which is read by and written to removable storage drive 414. As will be appreciated, the removable storage unit 418 includes a computer usable storage medium having stored therein computer software and/or data. In some examples, one or more of the main memory 408, the secondary memory 410, the removable storage unit 418, and/or the removable storage unit 422 may be a non-transitory memory.

Alternative aspects of the present disclosures may include secondary memory 410 and may include other similar devices for allowing computer programs or other instructions to be loaded into computer system 400. Such devices may include, for example, a removable storage unit 422 and an interface 420. Examples of such may

include a program cartridge and cartridge interface (such as that found in video game devices), a removable memory chip (such as an erasable programmable read only memory (EPROM), or programmable read only memory (PROM)) and associated socket, and the removable storage unit 422 and the interface 420, which allow software and data to be transferred from the removable storage unit 422 to computer system 400.

Computer system 400 may also include a communications circuit 424. The communications circuit 424 may allow software and data to be transferred between computer system 400 and external devices. Examples of the communications circuit 424 may include a modem, a network interface (such as an Ethernet card), a communications port, a Personal Computer Memory Card International Association (PCMCIA) slot and card, etc. Software and data transferred via the communications circuit 424 are in the form of signals 428, which may be electronic, electromagnetic, optical or other signals capable of being received by the communications circuit 424. These signals 428 are provided to the communications circuit 424 via a communications path (e.g., channel) 426. This path 426 carries signals 428 and may be implemented using wire or cable, fiber optics, a telephone line, a cellular link, an RF link and/or other communications channels. In this document, the terms “computer program medium” and “computer usable medium” are used to refer generally to media such as the removable storage unit 418, a hard disk installed in hard disk drive 412, and signals 428. These computer program products provide software to the computer system 400. Aspects of the present disclosures are directed to such computer program products.

Computer programs (also referred to as computer control logic) are stored in main memory 408 and/or secondary memory 410. Computer programs may also be received via communications circuit 424. Such computer programs, when executed, enable the computer system 400 to perform the features in accordance with aspects of the present disclosures, as discussed herein. In particular, the computer programs, when executed, enable the processor 404 to perform the features in accordance with aspects of the present disclosures. Accordingly, such computer programs represent controllers of the computer system 400.

In an aspect of the present disclosures where the method is implemented using software, the software may be stored in a computer program product and loaded into computer system 400 using removable storage drive 414, hard disk drive 412, or the interface 420. The control logic (software), when executed by the processor 404, causes the processor 404 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of coupling a single mode (SM) fiber to a single photon emitter, comprising:
sequentially emitting a plurality of photons;
aligning first photons of the plurality of photons to a first multi-mode (MM) optical fiber of a plurality of MM optical fibers, the first MM optical fiber having a first numerical aperture larger than remaining numerical apertures of remaining optical fibers of the plurality of MM optical fibers;
aligning second photons of the plurality of photons to a second MM optical fiber based on a first alignment of the first photons to the first MM optical fiber, the second MM optical fiber having a second numerical aperture smaller than the first numerical aperture; and
aligning third photons of the plurality of photons to the SM fiber based on a second alignment of the second photons to the second MM optical fiber, the SM fiber having a third numerical aperture smaller than the second numerical aperture.

2. The method of claim 1, further comprising moving, after aligning the first photons to the first MM optical fiber, the second MM optical fiber such that the second MM optical fiber at least partially overlaps with a first region previously occupied by the first MM optical fiber.

3. The method of claim 1, further comprising moving, after aligning the second photons to the second MM optical fiber, the SM fiber such that the SM fiber at least partially overlaps with a second region previously occupied by the second MM optical fiber.

4. The method of claim 3, wherein moving the SM fiber comprises one or more of translating the SM fiber along one or more axes or rotating the SM fiber around the one or more axes.

5. The method of claim 1, further comprising, after aligning the first photons to the first MM optical fiber, sequentially aligning a subset of the plurality of photons to a subset of the plurality of MM optical fibers having decreasing numerical apertures.

6. The method of claim 1, wherein the plurality of MM optical fibers are arranged based on numerical apertures of the plurality of MM optical fibers.

7. The method of claim 1, wherein a first core area of the first MM optical fiber is at least one thousand times larger than a second core area of the SM optical fiber.

8. The method of claim 1, wherein aligning the first photons to the first MM optical fiber comprises:
emitting the first photons toward the first MM optical fiber; and
adjusting a first position of the first MM optical fiber to maximize a first ratio of first input photons entering the first MM optical fiber and first output photons exiting the first MM optical fiber.

9. The method of claim 8, wherein aligning the second photons to the second MM optical fiber comprises:
emitting the second photons toward the second MM optical fiber; and
adjusting a second position of the second MM optical fiber to maximize a second ratio of second input photons entering the second MM optical fiber and second output photons exiting the second MM optical fiber.

10. The method of claim 9, wherein aligning the third photons to the SM optical fiber comprises:
emitting the third photons toward the SM optical fiber; and
adjusting a third position of the SM optical fiber to maximize a third ratio of third input photons entering the SM optical fiber and third output photons exiting the SM optical fiber.

11. The method of claim 10, further comprising estimating a coupling efficiency of the SM optical fiber based on one or more of the first ratio and the third ratio.

12. A system, comprising:
a frame disposed on a stage, the frame comprises:
a plurality of multimode (MM) optical fibers with decreasing numerical aperture, the plurality of MM optical fibers being arranged on the frame, and
a single mode (SM) fiber; and
the stage configured to sequentially align each of the plurality of MM optical fibers and the SM fiber with at least one of an emitter or a detector.

13. The system of claim 12, wherein a first core area of a first MM optical fiber is at least one thousand times larger than a second core area of the SM optical fiber.

14. The system of claim 12, further comprising:
a controller configured to move the stage to sequentially align each of the plurality of MM fibers and the SM fiber.

15. The system of claim 14, further comprising:
the emitter and the detector.

16. The system of claim 15, wherein the controller is further configured to:
cause the emitter to sequentially emit a plurality of photons;
cause the stage to move to align first photons of the plurality of photons to a first MM optical fiber of the plurality of MM optical fibers, the first MM optical fiber having a first numerical aperture larger than remaining numerical apertures of remaining optical fibers of the plurality of MM optical fibers;
cause the stage to move to align second photons of the plurality of photons to a second MM optical fiber based on a first alignment of the first photons to the first MM optical fiber, the second MM optical fiber having a second numerical aperture smaller than the first numerical aperture; and
cause the stage to move to align third photons of the plurality of photons to the SM fiber based on a second alignment of the second photons to the second MM optical fiber, the SM fiber having a third numerical aperture smaller than the second numerical aperture.

17. The system of claim 16, wherein the controller is further configured to move, after aligning the first photons to the first MM optical fiber, the stage such that the second MM optical fiber at least partially overlaps with a first region previously occupied by the first MM optical fiber.

18. The system of claim 16, wherein the controller is further configured to move, after aligning the second photons to the second MM optical fiber, the stage such that the SM fiber at least partially overlaps with a second region previously occupied by the second MM optical fiber.

19. The system of claim 16, wherein the controller is further configured to, after aligning the first photons to the first MM optical fiber, sequentially align a subset of the plurality of photons to a subset of the plurality of MM optical fibers having decreasing numerical apertures.

20. The system of claim 16, wherein the controller is further configured to estimate a coupling efficiency of the SM optical fiber based on one or more of the first photons and the third photons.
